(19) United States
(12) Patent Application Publication
(10) Pub. No.: US 2014/0088733 A1
(43) Pub. Date: Mar. 27, 2014

(54) Apparatus and Method for Machine Parameterization by Means of Smart Devices

(71) Applicant: Robert Bosch GmbH, Stuttgart (DE)

(72) Inventors: Sebastian Krauskopf, Gemuenden-Schaippach (DE); Jens Reckwell, Lohr Am Main (DE); Andreas Sokoll, Zellingen (DE); Christopher Sokoll, Himmelstadt (DE)

(73) Assignee: Robert Bosch GmbH, Stuttgart (DE)

(21) Appl. No.: 14/032,017

(22) Filed: Sep. 19, 2013

(30) Foreign Application Priority Data
Sep. 21, 2012 (DE) 10 2012 018 716.5

(51) Int. Cl. G05B 15/02

(52) U.S. Cl. CPC G05B 15/02
USPC 700/17

(57) ABSTRACT

A method for operating a machine having at least one working device configured to carry out predefined working sequences, and a control device configured to control the at least one working device. At least one operating parameter of the at least one working device being changeable by an input device. The input device includes a portable computer device, and the input device is configured to be operated independently of the machine.

This application claims priority under 35 U.S.C. §119 to patent application no. DE 10 2012 018 716.5, filed on Sep. 21, 2012 in Germany, the disclosure of which is incorporated herein by reference in its entirety.

### BACKGROUND

The present disclosure relates to an apparatus and a method for machine parameterization. When using diverse machines, for example processing machines or else machine tools, it is often necessary to set the machine parameters to diverse conditions, such as the tool elements used or else environmental conditions.

In the prior art, very expensive measuring systems and also complicated measuring methods are often used to acquire machine data, statistics and the dynamics by means of sensors for the purpose of this parameterization. On this basis, the object of the present disclosure is to simplify the parameterization, in particular by using simpler measuring methods and learning methods. In particular, the intention is for it to be possible to use consumer products, for example smart devices, in particular iPods, iPads or the like, to be used for this parameterization. In particular, the intention is to be able to use such products in order to optimize machines in automation technology. The disclosure is therefore used in particular on machines which preferably have a plurality of drives and preferably also control devices controlling these drives.

In particular, the intention is also to create a possible way of achieving simple optimization of drive controllers and, for example, also motor settings by utilizing such smart devices. The prior art discloses, for example, methods in which machine data is monitored with the aid of measuring methods and an evaluation is carried out exclusively on the computer. However, these methods are likewise relatively complicated and cannot be used in any desired machine types either.

A further object of the disclosure therefore consists in achieving cost-effective optimization of automation systems, in particular by using smart devices.

According to the disclosure, these objects are achieved by the subjects of the independent claims. Advantageous embodiments and developments are the subject of the sub-claims.

### SUMMARY

In a method according to the disclosure for operating a machine, the machine has at least one working device which carries out predefined working sequences. Furthermore, the machine has a control device for controlling this working device, and at least one operating parameter of this working device can be changed. In this case, this operating parameter is changed by means of an input device.

According to the disclosure, the input device used is a computer device that is portable and can be operated independently of the machine.

Therefore, in particular, parameterization or configuration of a control device and in particular of an automation control system is made possible. Advantageously, this parameterization or configuration is carried out with regard to a multiplicity of possible machine components which have been connected to the machine or are connected to the machine. The automation control system can have knowledge about the characteristics of the machine components connected thereto.

A working device is understood to mean a machine part or a machine device which is able to carry out predefined working sequences. This is preferably a working device which has one or more drives. In addition, however, a working device is also understood to mean a working device which carries out operations, for example by means of lasers or other working means. An operating parameter of this working device is understood to mean those parameters which also act in particular on the working sequences, such as in particular speeds of a working device, torques, outputs, displacement distances and the like.

In addition to the procedure described here, however, the machines can also further have measuring elements which measure specific physical values, such as torques, temperatures and the like. In addition, the values evaluated by these measuring devices can be taken into account during the parameterization.

Advantageously, the computer device outputs a signal which identifies it uniquely. In a further advantageous method, the working device has at least one drive. The machine is advantageously a machine tool.

In a further advantageous method, the computer device is in wire-free communication with the machine, at least from time to time.

Advantageously, the working device carries out working sequences by using at least one working element or a machine component, and this working element can be replaced by another working element, the operating parameters also depending on the selection of this working element.

These working elements are usually, for example, actuators or sensors, such as drives, linear guides, spindles, relays, analog and digital outputs or inputs and more. These working elements can have various characteristics, which are selected from a group of characteristics which, in particular but not exclusively, includes dimensions, weights, maximum load-bearing abilities, maintenance intervals, service information, spindle pitches, maximum range of travel, communications settings and more. Properties of this type can usually be found in an associated datasheet belonging to this working element. Without this information, interaction between the automation control system and the working element is impossible or not completely possible. Since there are many different actuators and sensors for an automation control system and the combination is virtually any desired, the automation control system is supplied without any parameterization relating to the machine components thereof.

As mentioned above, this parameterization previously had to be derived by the user manually or by using a datasheet and transmitted to the automation control system by input via PC software. The disclosure therefore suggests optimizing this operation by, in particular but not exclusively, the task of identifying the machine components and transmitting the necessary data being carried out by the computer device mentioned. This computer device is advantageously a smart device.

Particularly preferably, the computer device has an acquisition device which acquires at least one feature which is relevant to the setting of the operating parameter. For example, the identification of the machine component can be carried out via an incorporated camera, for example by using a bar code, a QR code or else via image recognition or via NFC (near field communication). The corresponding bar codes, QR codes, NFC transponders and the like are preferably already fitted by the manufacturer during the fabrication of the machine components (for example adhesively bonded on) and, in addition to an identification number about the component type, preferably also have a unique serial number.

In the aforementioned codes and in particular in the QR code, a multiplicity of items of data which relate to the drive or the linear system can be stored. For example, data, and in particular mechanical data which is required to activate the drive, can be stored.

By using this identification number, the computer device, in particular a smart device, is able to derive the aforementioned characteristics or specifications and parameterization. This is advantageously carried out via a database which, for example, is available locally on the computer device or also remotely (for example via a communication network such as the Internet). In a further advantageous method, properties which have not been determined or could not be determined or which are individual to the machine are supplemented by a user. To this end, a dialog-assisted input is advantageously used, in particular a dialog-assisted input on the computer device.

It would also be possible to combine the reading described here of the respective working elements with the method known from the prior art, i.e. additionally to measure further parameters in the machine in order, if appropriate, to adapt missing operating parameters or to change the latter within predefined ranges.

It is therefore in particular suggested that the sensor technology already present in computer devices or smart devices be used for parameterization. In addition, by means of the combination and evaluation of various sensors of such smart devices (such as acceleration sensors, position sensors, sound sensors, and so on), it is possible to determine measuring methods which also acquire the statics in the vibration response and the dynamics of a machine. By using this acquired data, the machine parameters can be optimized. For example, it would be possible for acoustic measurements of a machine to be performed by means of a smart device and for the parameters to be optimized by using said measurements. In this way, the continuously occurring improvements of the sensors incorporated in such smart devices can preferably also be used in this way to improve the measurement results and the optimizations.

A further advantage consists in the fact that the expenditure in terms of time for optimizing a machine can also be reduced. As a rule, machines adjusted optimally in this way have a higher life expectancy and can also operate with an improved cycle time.

Advantageously, the computer subsequently carries out parameterization of the machine control system. This can advantageously be carried out via an interface, for example WLAN, Ethernet or USB.

In a further advantageous method, the display device outputs a parameterization report, in particular a parameterization report which has been created or output by the control system.

Advantageously, a report can be output which also lists successful, defective, contradictory or else further lacking parameterization settings. These properties can advantageously be displayed to the user on the computer device, in particular a smart device.

Following the latter, this procedure can be carried out for further machine components.

Advantageously, the computer device acquires said feature optically and/or without contact. In particular, a camera can be used here. However, it would also be possible, for example, for GPS data, torques or else bar codes or even acoustic signals to be evaluated.

In a further advantageous method, the computer device acquires at least one feature characteristic of at least one working element. As mentioned above, this feature can be acquired by reading a bar code or the like. However, it would also be possible for an image of the working element to be recorded and for the latter to be compared with a database, for example.

In a further advantageous method, the machine interacts with at least one further working device or a further working element during working operation, and this working device and the operating parameter also depend on the selection of this working device. For example, in the case of different machine components, different operating parameters may be necessary. In other words, here the computer device acquires a multiplicity of machine elements or working elements and transmits the characteristic data thereof in particular to the control device, which can then carry out parameterization automatically or else instruct a user appropriately during the parameterization (for example via dialogs). In this way, during the parameterization, the environment or periphery of a machine device can also be taken into account. For example, it would be possible, for example, for a specific machine to be integrated into an arrangement having a plurality of machines or units and for the parameterization described here to be performed.

In a further advantageous method, a storage device is provided in which characteristic data for at least one working device and/or for at least one working element is stored. This storage device, as mentioned above, can be implemented as a database, for example, which is stored in the computer device but, if appropriate, this database can also be retrievable via the Internet.

In the process, the user can for example detect a specific working element and a processor device can then set specific working parameters. As mentioned above, a multiplicity of working devices or machine elements is preferably read in in this way and a multiplicity of parameters is also set, stored and/or changed in this way.

The present disclosure is, furthermore, directed to a machine having at least one first working device, which working device is suitable to carry out predefined working sequences.

Furthermore, the machine has a control device for controlling the working device, it being possible for at least one operating parameter of this working device to be changed. Furthermore, the machine has a replaceable working element which interacts with the working device in order to carry out the working sequence, the control device controlling the working device on the basis of at least one operating parameter that can be changed. Here, this operating parameter also depends on the selection of the working element. Furthermore, the machine has an input device, by means of which the setting of this operating parameter can be carried out.

According to the disclosure, the input device is a portable input device which has an acquisition device for identifying the working element, and a processor device which, on the basis of the working element identified, outputs at least one signal to the control device, it being possible for the operating parameter to be set in reaction to this signal.

It is therefore also suggested, in terms of apparatus, that the input device for parameterization be implemented as a portable computer device and in particular as a smart device.

Advantageously, the machine has access to a storage device, in which a multiplicity of items of data which are characteristic of the working elements is stored. In this way, a multiplicity of operating parameters can also be changed. Furthermore, the multiplicity of working elements of the machine can also be added in this way and corresponding, in particular automated, parameterization can be performed.

The acquisition device is advantageously an acquisition device which identifies the respective working element without contact.

### BRIEF DESCRIPTION OF THE DRAWINGS

Further advantages and embodiments can be gathered from the appended drawings, in which:

FIG. 1 shows a schematic sequence relating to the parameterization of the machine; and

FIG. 2 is a schematic representation of a machine according to the disclosure.

### DETAILED DESCRIPTION

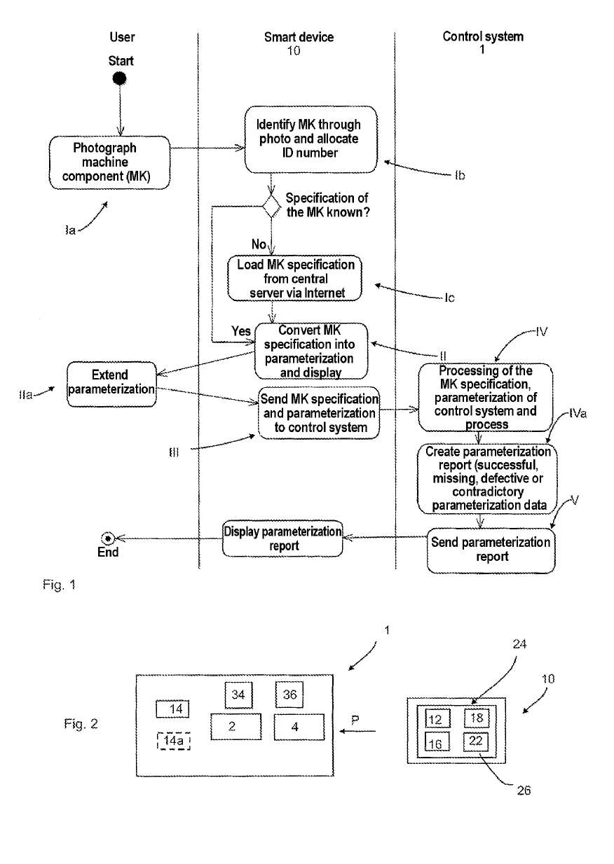

FIG. 1 shows a schematic sequence relating to the parameterization of a machine. In the left-hand column, the activities of a user are illustrated, in the central column the procedures which are carried out by the computer device and, in the right-hand column, those manipulations that are carried out by the control device of the machine.

At the start of the method, a machine component (MK) is photographed by the user (step Ia). This can be done by means of the computer device, such as a smart device. Instead of photography, however, it would also be possible for example to detect a bar code or the like arranged on the machine component or else a smart label.

In a further method step (step Ib), said image is assigned an identification, such as identification number (ID). This allocation can be carried out by using the computer device. For this purpose, the computer device can identify the photograph and, for example, can compare the latter with a reference photograph in a database, in order in this way to assign the number. If this identification number or the specification is known, the computer device can convert this specification into a specific parameterization or predefined specific parameters and preferably then display the latter to the user (step II).

If the specification is not known, an appropriate specification can be loaded, for example via the Internet or else via a central server. It would also be possible at this point for the user to be requested to input a specification (step Ic).

If the parameterization is not yet complete, as mentioned above, it is optionally possible for the parameterization to be extended by the user (step IIa). Then, following completion of the parameterization, this parameterization is sent to the control device of the machine, advantageously together with the machine component specification (step III).

The control device advantageously then processes the the machine component specification and the parameterization is implemented in the machine (step IV.

Optionally, a parameterization report can subsequently be created, for example about successful, defective or contradictory parameterization data. This report can in turn optionally be output to the user via the computer device. In any case, this parameterization report can also be sent (step V), for example to other users or else to the smart device 10. The parameterization report can also be displayed to the user (step VI). For this purpose, as mentioned above, the computer device preferably has a display device such as a display. Advantageously, the computer device also has a touch sensitive display, so that the individual operations, such as photographing or recording the machine component, can be carried out via a direct input on the screen. The computer device can also give the user instructions as to how a specific machine component is to be recorded, for example from which angle the latter is to be photographed.

FIG. 2 shows a schematic representation of a machine 1 according to the disclosure. This machine has a working device 2, such as a drive, which can be fitted with a working element 14 or (illustrated dashed) another working element 14a. Depending on this working element, the parameterization of this drive and of the control device 4 which controls said drive 2 changes. Designation 10 identifies an input device with which the aforementioned parameterization can be carried out. For this purpose, operating parameters P can be transmitted to the control device 4 from the input device 10. However, it would also be possible for other signals or information to be transmitted and for the control device 4 to determine the operating parameters only appropriately therefrom.

The input device 10 has a display device 24 and this in turn has a touch-sensitive surface 26. In this way, the user, as known from the prior art, is able to input commands directly by making contact with this surface. Designation 12 identifies (likewise schematically) an acquisition device, such as a photographic camera, for example, with which a working element 14 can be recorded. Designation 16 identifies a storage device, with which, for example, a multiplicity of images is stored, a comparison device 18 further being provided, which compares an image recorded by the image acquisition device 12 with images stored in the database or storage device 16. As a reaction to this comparison, the appropriate operating parameter P can be output to the control device 4. A processor device 22 uses the recorded command to determine the necessary parameters and outputs an appropriate signal to the machine or to the control device 4 of the latter.

The machine 1 can have still further working devices 2 and drive devices, which can each be fitted with different working elements 14. In addition, as mentioned above, there can also be a multiplicity of further working elements which each interact with the working device 2. The parameterization of the working device 2 can also be carried out for the further working elements 34, 36. Advantageously, the user will therefore read in one working element after the other successively and carry out the parameterization and/or have the parameterization carried out appropriately.

The applicant reserves the right to claim all the features disclosed in the application documents as important to the disclosure if they are novel as compared with the prior art, individually or in combination.

### LIST OF DESIGNATIONS

ID Identification number
MK Machine component
P Operating parameter
1 Machine
2 Working device/drive
4 Control device
10 Smart device/input device/computer device
12 Acquisition device
14 Working element
14a Other working element
16 Storage device
18 Comparison device
20 Working device
22 Processor device
24 Display device
26 Surface
34 Working elements
36 Working elements

What is claimed is:

1. A method for operating a machine comprising:
carrying out predefined working sequences with at least one working device;
controlling the at least one working device with a control device;
changing at least one operating parameter of the at least one working device with an input device, the input device including a computer device that is portable; and
operating the input device independently of the machine.

2. The method according to claim 1, wherein the computer device is in wire-free communication with the machine, at least from time to time.

3. The method according to claim 1, wherein:
the at least one working device carries out the predefined working sequences by using at least one working element,
the at least one working element is configured to be replaced by at least one other working element, and
the at least one operating parameter also depends on a selection of at least one of (i) the at least one working element, and (ii) the at least one other working element.

4. The method according to claim 1, wherein:
the computer device includes an acquisition device configured to acquire at least one feature, and
the at least one feature is relevant to a setting of the at least one operating parameter.

5. The method according to claim 4, wherein the computer device is configured to acquire the at least one feature optically and/or without contact.

6. The method according to claim 3, wherein the computer device is configured to acquire at least one feature characteristic of at least one of (i) the at least one working element, and (ii) the at least one other working element.

7. The method according to claim 6, wherein:
the machine is configured to interact with at least one further working device and/or a further working element during working operation, and
the at least one further working device and the at least one operating parameter also depend on the selection of the at least one further working device.

8. The method according to claim 1, further comprising:
a storage device configured to store characteristic data for at least one working device and/or for at least one working element.

9. A machine comprising:
at least one first working device, the at least one first working device being suitable to carry out predefined working sequences;
a control device configured to control the at least one first working device, at least one operating parameter of the at least one first working device being changeable;
at least one replaceable working element configured to interact with the at least one first working device to carry out the predefined working sequences, the control device controlling the at least one first working device based on the at least one operating parameter that is changeable, the at least one operating parameter also depending on a selection of the at least one replaceable working element;
an input device configured to carry out a setting of the at least one operating parameter, the input device being a portable input device including (i) an acquisition device configured to identify the at least one replaceable working element, and (ii) a processor device configured to, based on the identification of the at least one replaceable working element, output at least one signal to the control device, and the at least one operating parameter being set in reaction to the at least one signal.

10. The machine according to claim 9, wherein:
the machine is configured to have access to a storage device,
the storage device is configured to store a plurality of items of data, and
the plurality of items of data are characteristic of the at least one replaceable working element.
